(19) United States
(12) Patent Application Publication
(10) Pub. No.: US 2015/0254512 A1
(43) Pub. Date: Sep. 10, 2015

(54) KNOWLEDGE-BASED APPLICATION OF PROCESSES TO MEDIA

(71) Applicant: Lockheed Martin Corporation, Bethesda, MD (US)

(72) Inventors: Kevin Newman, Berwyn, PA (US); Allison Mackenzie Mathis, Philadelphia, PA (US); Steven M. Wilder, Westfield, NJ (US); Paul Barros, Newbury Park, CA (US)

(73) Assignee: Lockheed Martin Corporation, Bethesda, MD (US)

(21) Appl. No.: 14/197,923

(22) Filed: Mar. 5, 2014

(51) Int. Cl. G06K 9/00

(52) U.S. Cl. CPC G06K 9/00744; G06K 2009/00738

(57) ABSTRACT

A processing system and method for reviewing and tagging streams of media are disclosed. For example, a processing system for processing a media stream can include rules processing circuitry configured to determine whether to apply one or more media processes to a stream of received media based on mission criteria, wherein the mission criteria defines at least one concept, object or event of interest that is sought for in the received media stream, and variable processing circuitry configured to apply any of a number of known processes on the received media stream based on commands received from the rules processing circuitry.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

The amount of sensor-based data often outpaces the human resources that can be dedicated to observing such data. For example, video streams from observation drones and fixed cameras for a secure facility, such as an embassy, can require dozens of people to review all the data with the necessary attention to detail. This issue is compounded when different agencies or analysts are required to review the same video streams to look for different information.

### SUMMARY

Various aspects and embodiments of the invention are described in further detail below.

In an embodiment, a processing system for processing a media stream includes rules processing circuitry configured to determine whether to apply one or more media processes to a stream of received media based on mission criteria, wherein the mission criteria defines at least one concept, object or event of interest that is sought for in the received media stream, and variable processing circuitry configured to apply any of a number of known processes on the received media stream based on commands received from the rules processing circuitry.

In another embodiment, a method for processing system a media stream includes receiving a media stream, determining whether to apply one or more media processes to a stream of received media based on mission criteria, wherein the mission criteria defines at least one object or event of interest that is sought for in the received media stream, and applying any of a number of known processes on the received media stream based on commands received from the rules processing circuitry.

### BRIEF DESCRIPTION OF THE DRAWINGS

Various embodiments of this disclosure that are proposed as examples will be described in detail with reference to the following figures, wherein like numerals reference like elements, and wherein:

FIG. 1 is a block diagram of a media processing system.

FIG. 2 depicts various components of a received media stream.

FIG. 3 is a block diagram of the processing circuitry of FIG. 1.

FIG. 4 is a flowchart outlining an example set of operations usable to process a media stream and tag portions of interest.

### DETAILED DESCRIPTION OF EMBODIMENTS

The disclosed methods and systems below may be described generally, as well as in terms of specific examples and/or specific embodiments. For instances where references are made to detailed examples and/or embodiments, it is noted that any of the underlying principles described are not to be limited to a single embodiment, but may be expanded for use with any of the other methods and systems described herein as will be understood by one of ordinary skill in the art unless otherwise stated specifically.

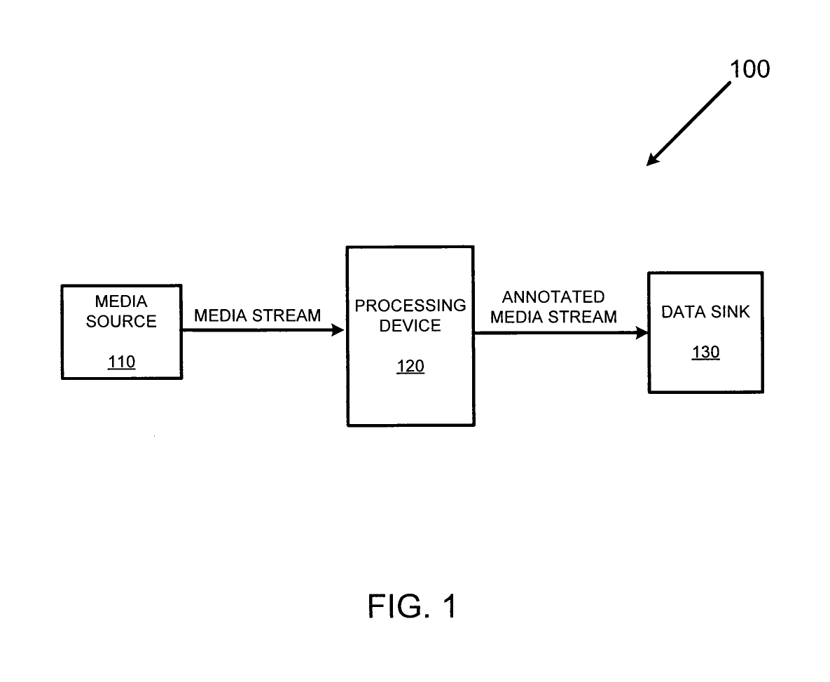

FIG. 1 is a block diagram of a media processing system 100. As shown in FIG. 1, the media processing system 100 includes a media source 110, processing circuitry 120 and a data sink 130.

In operation, the media source 110 provides one or more streams of media data to the processing circuitry 120. The processing circuitry 120, in turn, receives and processes the one of more media streams according to a number of fixed processes and according to a number of variable processes that can change according to a variety of conditions that will be described below in greater detail. The processing circuitry 120 then tags portions of the media stream that, according to a predefined set of parameters, will be of likely interest to a human analyst and/or additional data analysis processes. The processing circuitry 120 then provides the tagging information along with any pertinent details as to what was tagged to the data sink 130.

The media source 110 can be any of a large variety of sensors. For example, the media source can be a camera capable of sensing light in the human visual range, a camera capable of capturing infrared images, ultraviolet images, or a combination thereof. The media source 110 can also be an acoustic sensor, a voltage and/or current sensor, a radar sensor, a seismic sensor or any other known or later developed set of one or more transducers that can be used to transform physical information into an information data stream.

The exemplary processing circuitry 120 is a collection of communicatively coupled processing systems, e.g., computers and/or servers, controlled by software and/or firmware. However, the exact configuration of the processing circuitry 120 can vary to include dedicated hardware-based processing systems, dedicated digital signal processors, and so on as may be found advantageous or otherwise useful.

The exemplary data sink 130 is a computer having data-storage capacity capable of storing tagging information any other information for at least one data stream. In other embodiments, however, the data sink 130 can take the form of a simple memory device, a complex array of computers capable of storing data, or of a mere display capable of displaying data to a human observer.

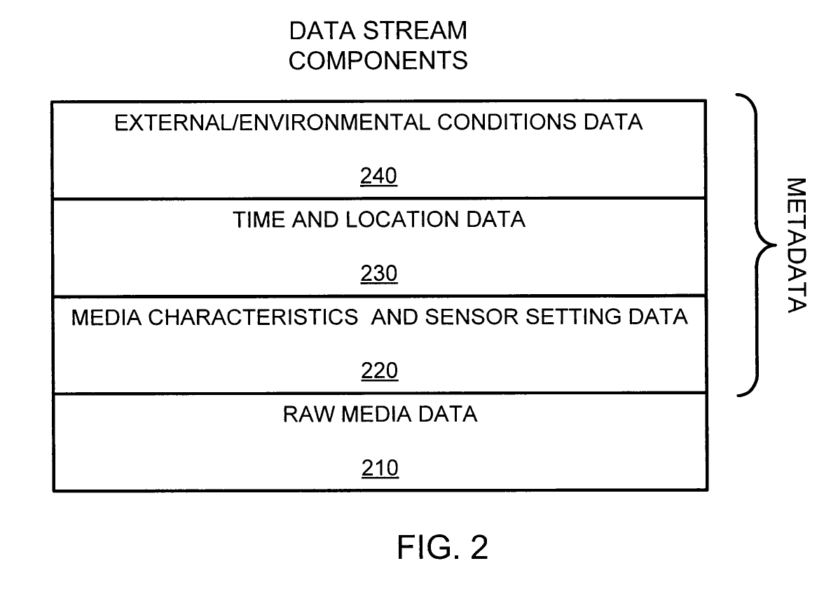

FIG. 2 depicts various components of an exemplary received media stream. As shown in FIG. 2, such components can include raw data 210, media characteristics and sensor settings 220, time and location information 230 and external/environmental conditions data 240. For the purposes of this disclosure, the “raw data” 210 is limited to data produced by a particular sensor, such as a video sensor, a radar or sonar sensor, and so on. The remaining data 220, 230 and 240 are different forms of metadata. For the purposes of this disclosure, the term “metadata” can apply to data that in some way describes some attribute of the raw data, such as a time the data stream originated, the location the data stream originated, spectral characteristics (e.g., spectral range and sensor sensitivity) of the raw data stream's sensor, camera angle, camera zoom and so on. The term “metadata” can also apply to any number of environmental conditions, such as ambient temperature, weather data, ambient light levels, electro-magnetic interference, and so on. Generally, the metadata can be expected to change with the form of sensor used. For example, a towed sonar array will unlikely include metadata about ambient light but may include motion data and information about the relative spacing between individual sonar elements.

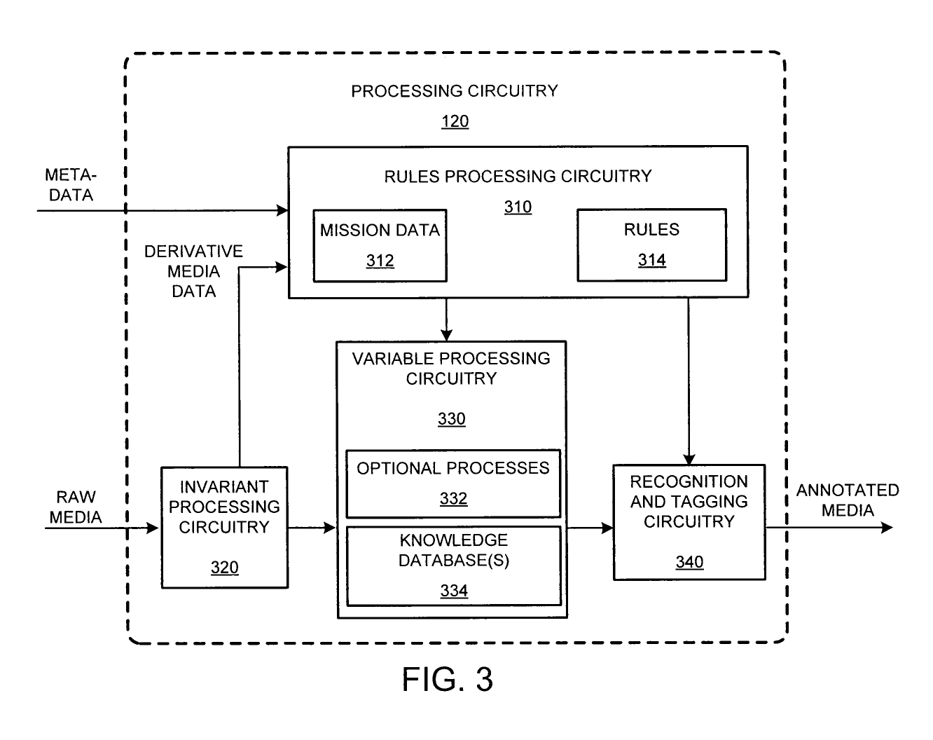

FIG. 3 is a block diagram of the processing circuitry 120 of FIG. 1. As shown in FIG. 3, the processing circuitry 120 includes rules processing circuitry 310, invariant processing circuitry 320, variable processing circuitry 330 and recognition and tagging circuitry 340. The rules processing circuitry 310 includes a variety of embedded information, including mission data 312 and a set of operative rules 314. The variable processing circuitry 330 includes a collection of optional processes 332 and knowledge databases 334.

Although the processing circuitry 120 of FIG. 3 is depicted as a collection of separate circuits connected by a variety of data/command buses, it should be appreciated that any other circuitry architecture may be used as is well known to those of ordinary skill in the art. For example, in various embodiments, the various component circuits 310-340 can take form of separate processing systems coupled together via one or more networks and employed in a cooperative fashion.

It also should be appreciated that some or all of the above-listed component circuits 310-340 can take the form of software/firmware routines residing in a computer memory capable of being executed by a processor, or even software/firmware routines residing in separate memories in separate computing systems being executed by different controllers.

Prior to operation, the rules processing circuitry 310 can be provided with mission data/criteria, which defines at least one concept, object or event of interest that is sought for in a received media stream. For example, a user may be interested in mining video footage taken from a variety of drone aircraft to determine traffic patterns or animal migration. Similarly, a user may be interested in mining video footage taken from a variety of fixed cameras to determine how many cars drive down a particular road, the likely identity of pedestrians (based on facial recognition), or both. Such mission data/criteria can be important because it can influence the type of processing that may be deployed at any given time. By way of example, if a user is not interested in identifying facial features from a security camera, then the rules processing circuitry 310 will not populate the rules 314 to enable facial identification routines. By way of a second example, if a user wishes to identify “concepts,” such as a pattern of events or orientation of objects, the rules processing circuitry 310 may populate the rules 314 to identify not just objects and/or events, but also rules that relate to, for example, generalized interactions and relationships of objects and/or events.

In addition to mission directives, the rules processing circuitry 310 can also receive the metadata 220-240 associated with the raw data 210 of FIG. 1. Such metadata 220-240 can act to establish the rules 314 or to operate according to the rules. For instance, if the metadata 220-240 includes information that the raw data 210 is unreliable for facial recognition because the raw data 210 is a video stream in the far infrared, then the rules 314 can include a directive to never deploy facial recognition. On the other hand, if metadata 220-240 includes information that the raw data 210 is only sometimes unreliable for facial recognition because of transient ambient light conditions, then the rules 314 can include a directive to deploy facial recognition algorithms, but not issue a command to deploy such algorithms unless ambient light is sufficient for reliable facial recognition. Generally, metadata of interest can include a type of sensor used to create the received media stream, any configuration of the sensor, sensor resolution, the particular environmental conditions in which the received media stream was created, and any other possible data associated with a raw data stream that might be used to determine a useful set of processes.

In addition to mission directives and metadata, the rules processing circuitry 310 can receive derivative media data from the invariant processing circuitry 320. That is, as raw media is fed to the invariant processing circuitry 320, the invariant processing circuitry 320 can perform two different categories of processes that will not likely change over the course of a media stream review.

The first category of processes can change some quality of the raw media. Resolution changes, data reformatting, spatial and/or temporal interpolation, edge enhancement, and contrast changes are but a few examples.

In contrast to the first category, the second category of processes operate to extract information from the raw data, such as whether there is some form of occlusion hindering a sensor (e.g., dust, smoke, temperature inversions), what is the ambient light level, and whether there is some motion detected and/or what is a total amount of motion detected are but a few examples. Issues such as dust, smoke or some other particulate matter may affect which algorithm/process might be best suited to accomplish a particular task where the raw data is a multispectral video feed. Similarly, other derived information can act upon a set of rules to determine the best possible subsequent processing.

After the rules processing circuitry 310 has established a set of rules and applied metadata and/or derived data to the rules, the rules processing circuitry 310 can issue commands to the variable processing circuitry 330 and to the recognition and tagging circuitry 340.

The variable processing circuitry 330 can receive the raw data from the invariant processing circuitry 320 and, based on a set of commands from the rules processing circuitry 310, operate on the raw data using the appropriate processes/algorithms from its cache of available optional processes 332 and knowledge database(s) 334. For instance, if there is a directive to determine what types of vehicles are traversing a stretch of desert, then the variable processing circuitry 330 can execute a set of algorithms to detect physical features of moving objects found in a raw data stream, and compare such detected features to features of known things to determine, for instance, whether a moving object is a car, an armored vehicle or an animal.

Events, as well as objects, may be discerned by the variable processing circuitry 330. Car crashes, for example, may be detected in addition to detecting the type of vehicles found on a road. Explosions, fires, animal crossings and any other temporal event may also be detected.

After the variable processing circuitry 330 has performed the requisite processing, the variable processing circuitry 330 can provide information about the raw data to the recognition and tagging circuitry 340. In turn, the recognition and tagging circuitry 340 can make a determination as to whether some recognition threshold is met and/or whether an event or object detected is of likely interest to an analyst or other user. If an object or event detected by the variable processing circuitry 330 meets some basic criteria or threshold, then the recognition and tagging circuitry 340 can tag those portions of the raw media containing the event or object. Accordingly, an analyst that needs to review a particular stream of data can concentrate on only those portions likely to be of interest, or altogether avoid any media footage while reviewing, for example, the times and locations of recognized objects and events.

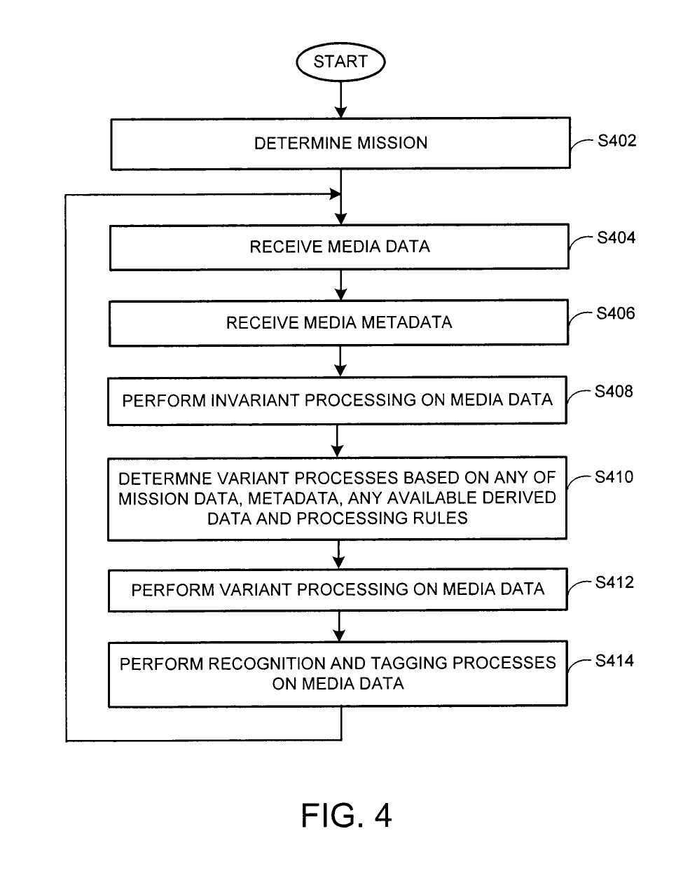

FIG. 4 is a flowchart outlining an example set of operations usable to process a media stream and tag portions of interest. While the below-described operations are described as occurring in a particular sequence for convenience, it is noted that the order of various operations may be changed from embodiment to embodiment. It is further noted that various operations may occur simultaneously or may be made to occur in an overlapping fashion.

The process starts at S402 where a mission, e.g., a set of criteria that defines at least one object or event of interest that is to be sought for in a received media stream, is determined/defined. Next, at S404 media data is received, and at S406 media metadata is received. Then, at S408 a set of invariant processes is performed on the media data. As discussed above, such invariant processes can change some quality of the raw media, such as resolution, data reformatting and edge enhancement, while other invariant processes can operate to extract information from the raw data, such as whether there is some form of occlusion hindering a sensor, what is the ambient light level, and/or motion detection information. Control continues to S410.

At S410 a set of variant process/algorithms to be deployed to accomplish the desired mission of S402 is determined based on any or all of the mission data of S402, the metadata of S406 and any derived data of S408. At S412, the desired processes/algorithms determined at S410 are performed on the media data.

At S414 recognition and tagging operations are performed so as to determination whether some recognition threshold is met and/or whether an event or object detected is of likely interest to an analyst or other user. If an object or event of interest is detected, then the respective portions of the raw media containing the event or object are tagged.

Control then jumps back to S404 where the operations of S404-414 are repeated as necessary or desired.

While the invention has been described in conjunction with the specific embodiments thereof that are proposed as examples, it is evident that many alternatives, modifications, and variations will be apparent to those skilled in the art. Accordingly, embodiments of the invention as set forth herein are intended to be illustrative, not limiting. There are changes that may be made without departing from the scope of the invention.

What is claimed is:

1. A processing system for processing a media stream, comprising:
rules processing circuitry configured to determine whether to apply one or more media processes to a stream of received media based on mission criteria, wherein the mission criteria defines at least one concept, object or event of interest that is sought for in the received media stream; and
variable processing circuitry configured to apply any of a number of known processes on the received media stream based on commands received from the rules processing circuitry.

2. The processing system of claim 1, further comprising:
recognition and tagging circuitry that recognizes concepts, objects or events of interest in the media stream based on commands received from the rules processing circuitry, and tags portions within the media stream that contain objects or events of interest.

3. The processing system of claim 1, further comprising:
invariant processing circuitry that performs one or more processes on the received media stream before the media stream is provided to the variable processing circuitry.

4. The processing system of claim 3, wherein
the invariant processing circuitry alters the received media.

5. The processing system of claim 3, wherein
the invariant processing circuitry derives data from the received media stream.

6. The processing system of claim 5, wherein
the rules processing circuitry is further configured to determine whether to apply one or more media processes to the stream of received media based on data derived from the invariant processing circuitry.

7. The processing system of claim 6, wherein
the rules processing circuitry is configured to determine whether to apply one or more media processes to the stream of received media based at least one of the following types of data derived from the invariant processing circuitry: sensor occlusion data, ambient light data, motion detection data, or other stream specific data derivation.

8. The processing system of claim 1, wherein
the rules processing circuitry is further configured to determine whether to apply one or more media processes to the stream of received media based on metadata associated with the received media stream.

9. The processing system of claim 8, wherein
the rules processing circuitry is configured to determine whether to apply one or more media processes to the stream of received media based at least one of the following types of metadata: a type of sensor used to create the received media stream, a configuration of the sensor, sensor resolution, and environmental conditions in which the received media stream was created.

10. The processing system of claim 1, wherein
the variable processing circuitry is configured to employ a knowledge database to perform at least one process.

11. The processing system of claim 10, wherein
the knowledge database includes at least one of: a database of facial features and a database of vehicle feature.

12. A method for processing system a media stream, comprising:
receiving a media stream; and
determining whether to apply one or more media processes to a stream of received media based on mission criteria using rules processing circuitry, wherein the mission criteria defines at least one concept, object or event of interest that is sought for in the received media stream; and
applying any of a number of known processes on the received media stream based on commands received from the rules processing circuitry.

13. The method of claim 12, further comprising:
recognizing concepts, objects and/or events of interest in the media stream based on commands received from the processing circuitry, and
tagging portions within the media stream that contain objects or events of interest.

14. The method system of claim 13, further comprising:
performing one or more invariant processes on the received media stream before the media stream is provided to the processing circuitry.

15. The method of claim 14, wherein
at least one invariant process alters the received media.

16. The method of claim 14, wherein
at least one invariant process derives data from the received media stream.

17. The method of claim 16, wherein
the determination of whether to apply at least one media process to the stream of received media is based on data derived from an invariant process.

18. The method of claim 17, wherein
determining whether to apply at least one of the one or more media processes to the stream of received media is based at least one of the following types of derived data: sensor occlusion data, ambient light data, motion detection data, and other stream specific data derivation.

19. The method of claim 13, wherein
determining whether to apply one or more media processes to the stream of received media is further based on metadata associated with the received media stream.

20. The processing system of claim 19, wherein
determining whether to apply at least one of the one or more media processes to the stream of received media is based at least one of the following types of metadata: a type of sensor used to create the received media stream, a configuration of the sensor, sensor resolution, and environmental conditions in which the received media stream was created.
